(19) United States
(12) Patent Application Publication
(10) Pub. No.: US 2008/0023918 A1
(43) Pub. Date: Jan. 31, 2008

(54) LEAK-BY SEALING SYSTEM FOR A SHUTTLE PISTON

(75) Inventors: Dan Strasser, Calgary (CA); Luis Figueroa, Calgary (CA)

Correspondence Address: SEAN W. GOODWIN, 222 PARKSIDE PLACE, 602-12 AVENUE S.W., CALGARY, AB, T2R 1J3, US

(73) Assignee: DYNETEK INDUSTRIES LTD., Calgary (CA)

(21) Appl. No.: 11/778,014

(22) Filed: Jul. 13, 2007

Related U.S. Application Data
(60) Provisional application No. 60/820,766, filed on Jul. 28, 2006.

(51) Int. Cl. F16J 9/28; F16K 31/124

(52) U.S. Cl. 277/448; 137/487.5

(57) ABSTRACT

A seal system is provided for a reciprocating shuttle piston in a piston bore. An annular seal ring is fit to a piston ring groove in the piston. The seal ring is split along a cut extending entirely through a depth of the ring from a first side to a second side and entirely through a width of the ring from an outer peripheral seal face to an inner face. A fluid pressure differential across the seal results in a leak-by or metered flow of fluid across the seal, such as to equilibrate pressure across the piston. In one embodiment, the leak-by seal is fit to a groove in a shuttle piston of a pilot operated valve, the piston having a first face for opening and closing a main flow passage and a second face communicating with a pilot or backpressure passage. In one operation, the seal ring can bleed fluid from the second face for altering the pressure differential across the piston.

### FIELD OF THE INVENTION

The invention relates to piston ring having controlled flow thereby. More particularly, a shuttle valve piston having piston seal enabling a small bypass flow enables pressure equalization for control of pressure differential operation of the shuttle valve.

### BACKGROUND OF THE INVENTION

On-off solenoid-triggered valves for high pressure operation are typically of the pilot-operated type. That is, a direct acting solenoid opens a small orifice, being typically 0.010″ to 0.030″ in diameter, which provides a small pilot flow. The pilot flow serves to charge the downstream system, slowly raising the pressure therein to the supply pressure. When the downstream pressure has nearly reached the supply pressure, a second stage of the valve or shuttle valve piston is able to open, allowing the primary flow orifice, being typically 0.156″ to 0.250″ in diameter, to provide normal, full-flow rates. Further, to the downstream system resets through flow of fluid into or out o the downstream system through an orifice. Additionally, at high supply pressures and with smaller system volumes, the delay time from pilot flow to full flow is substantially indiscernible. However, at low supply pressures, for example less than 500 psig, the delay time becomes significant and can often reach 30 seconds or more. Such delays are not tolerable in many applications, such as automotive applications. Accordingly, it is desirable to have a system with little delay, regardless of supply pressure, downstream pressure and flow demand conditions. Applicant has dealt with some of the aforementioned challenges in their co-pending co-owned application US 2005/0103382 A1, published May 19, 2005 and U.S. Pat. No. 6,540,204, issued Apr. 1, 2003.

As noted above, many applications for on-off solenoid triggered valves are increasingly likely to demand more critical performance of the leak-tight sealing of the shuttle piston across the system's entire pressure range, for example 5 to 875 bar or even higher pressures. In some applications, the maximum allowable leak rate may be created by a leakage path equivalent to a 5 μ-in (0.127 micron) diameter opening. Accordingly, conventional seal materials and configurations are often unable to reliably deliver the required performance. This is especially true for smaller molecule gases and higher operating pressures.

The shuttle valves are expected to be responsive and also be able to reset. The shuttle valve is a piston operable in a bore with one end operable to open and close the valve and the other end exposed to a chamber which has a pilot flow fluid passage for pressure control of the chamber and differential pressures across the piston. Due to the nature of the relative flows into and out of the chamber, the very small passages or bleed orifices are used which are difficult to manufacture and subject to plugging. The design of such shuttle valves includes both the mechanical properties of the shuttle valve and the pilot characteristics including pressure management.

There is a continuing need for fast-acting shuttle systems, systems operable under low pressure conditions such as in gaseous fuel systems, and having improved reliability.

### SUMMARY OF THE INVENTION

In one embodiment of the invention, a leak-by piston sealing ring is provided for controlled flow thereacross. In another embodiment, an improved shuttle valve for a fluid valve such as a pilot-operated regulator is provided. Such a fluid valve comprises a valve body having a main flow passage connecting a first area at a first pressure to a second area at a second pressure. A first shuttle valve is operative for opening and closing the main flow passage. The shuttle valve has a first shuttle face further having a seal face for alternately sealing the main flow passage, and has a backpressure face. The first shuttle face is in communication with the main flow passage between the seal face and the second area, the shuttle valve being biased for closing the main flow passage. A backpressure passage extends between the first area and the backpressure face and having a metering orifice therealong. A bleed passage extends between the second area and the backpressure face and has a bleed orifice therealong. The bleed orifice can be an embodiment of the leak-by sealing ring. A second valve is operable for opening and closing the metering or control orifice for controlling the shuttle valve and regulating flow through the fluid valve. When the control orifice is closed, the leak-by enables equilibrating of the second pressure across the piston. Alternatively, when the metering orifice is open, metered flow through the metering orifice exceeds leak-by flow across the sealing ring and piston operates at a differential pressure between the first and second pressures.

As described, the shuttle valve has a pressure equalization system thereacross. Rather than a known microscopic bleed port extending through the fluid valve to the backpressure face, as shown in Applicant's co-pending application US 2005/0103382, pressure is equalized across the leak-by sealing ring.

The leak-by piston seal is a split sealing ring fit to a piston in a piston bore closed by a chamber at one end and open to a flow passage at another. A seal system for metering fluid under differential pressure results comprising: a piston reciprocable in a cylindrical piston bore, the piston bore having a backpressure chamber at a backpressure face of the piston and an annular seal groove being open to the piston bore and having first and second side walls; and a unitary yet discontinuous annular sealing ring fit to the groove, the sealing ring having a center and an axial axis, a substantially cylindrical outer peripheral sealing face which is elastically compressible for sealingly engaging the piston bore at an annular interface, a first side face, a second side face, an axial depth between the first and second sides faces, an inner peripheral face and an annular width between outer peripheral sealing face and the inner peripheral face, the sealing ring further having an angled split entirely through its axial depth along a cut surface extending between a starting angular location at the first side face to a rotated angular location at the second side face and entirely through its annular width between the outer peripheral sealing face and the inner peripheral face, wherein a leak-by of fluid along the split of the sealing ring and along the annular interface for equalizing the differential pressure across the piston.

### BRIEF DESCRIPTION OF THE DRAWINGS

FIG. 1 is a cross-sectional view of a PRIOR ART valve installed in a pressure cylinder;

FIG. 2 is a close-up of a PRIOR ART shuttle valve according to the PRIOR ART valve of FIG. 1;

FIG. 3 is a cross-sectional view of a valve incorporating a leak-by sealing system implementing one embodiment of the invention;

FIGS. 4A and 4B are cross-sectional views of an embodiment of the sealing system in a partial cross-sectional view having a piston shown in the closed and open positions respectively;

FIG. 4C is a close-up exploded side view of a shuttle valve according to FIG. 3;

FIG. 4D is a close-up assembled and cross-sectional view of a shuttle valve according to FIG. 3;

FIG. 5 is a close up partial cross-sectional view of the annular interface between the piston, the sealing ring and the piston bore with fluid flow to the right;

FIG. 6 is an exploded side view of a piston having a piston ring groove for receiving the sealing ring;

FIG. 7 is a close up partial cross-sectional view of the annular interface between the piston, piston ring groove, the sealing ring and the piston bore demonstrating the migration or leak fluid flow path through the annular interface upstream of the ring, to the groove, through the sealing ring and exiting the sealing ring at the annular interface downstream of the sealing ring;

FIG. 8 is a perspective view of a sealing ring illustrating the cut surface therethrough;

FIGS. 9A, 9B and 9C are side, end and side cross-section views of a split sealing ring with a 70 degree cut;

FIGS. 10A, 10B and 10C are side, end and side cross-section views of a split sealing ring with a 80 degree cut;

FIGS. 11A, 11B, 11C and 11D are side cross-sectional, side end and perspective views of a piston suitable for an embodiment of the sealing system;

FIG. 12 is a cross-sectional view of the piston, a biasing spring and sealing ring with fluid flow paths which the shuttle valve is open;

FIG. 13 is a cross-sectional view of a high pressure solenoid valve illustrating vent flow from the backpressure face through the control orifice;

FIGS. 14A, 14B and 14C are side, end and perspective views respectively of the mandrel of a ring cutting apparatus;

FIGS. 16A, 16B, 16C, 16D and 16E are end, side cross-sectional, plan, partial plan view of FIG. 16C, and perspective views respectively of a cutting block according to the ring cutting apparatus of FIG. 14C; and

FIG. 17 is a perspective view of a mandrel, sealing ring and cutting blade according to the ring cutting apparatus of FIG. 14C.

### DETAILED DESCRIPTION OF EMBODIMENTS OF THE INVENTION

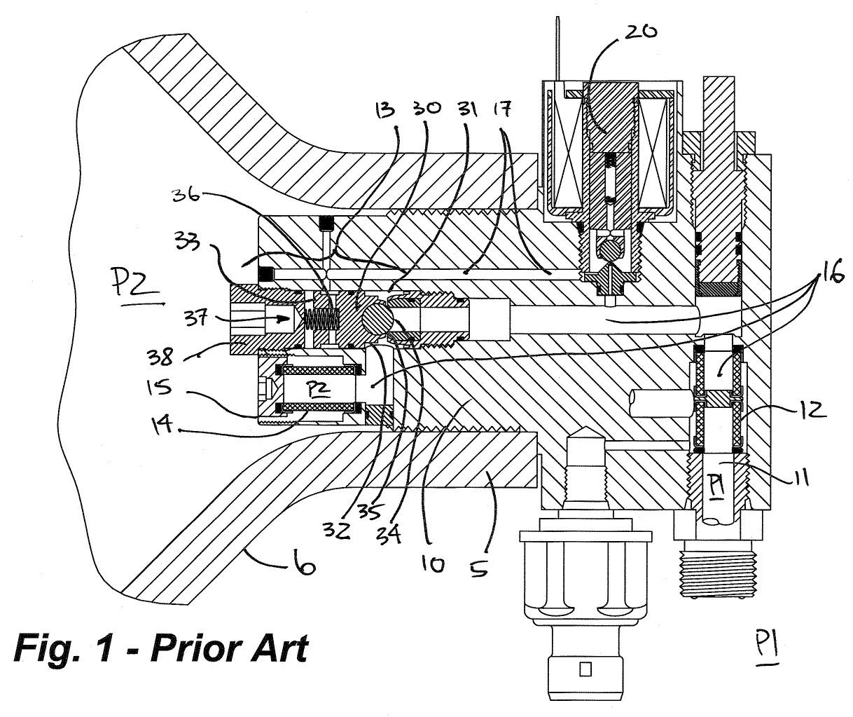

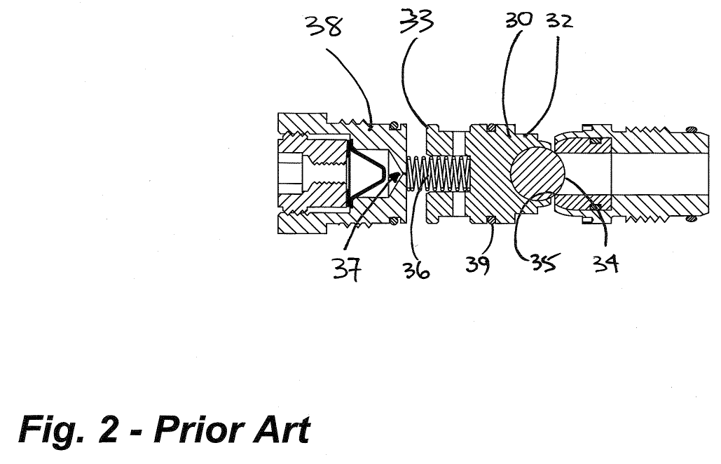

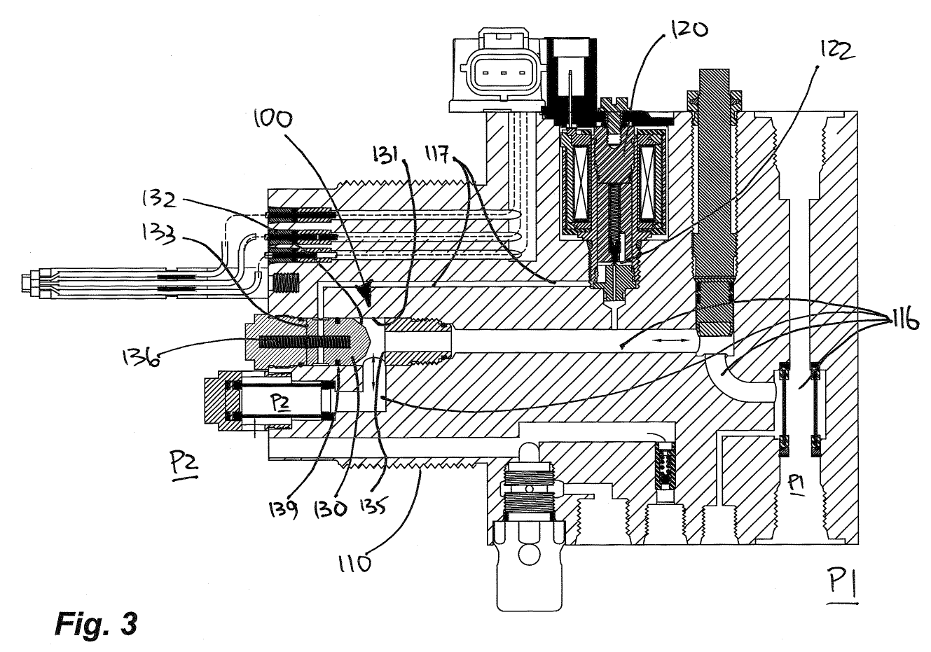

Pilot-operated valves, such as those set forth in FIGS. 1 and 2 and in particular for in-cylinder control valves, are illustrated herein as one context for embodiments of a sealing system for a modified valve as illustrated in FIG. 3. Often a pressure regulator is also associated with such valves but is not illustrated herein as a matter of clarity. Further, the sealing system is equally applicable to in-line remote valves which are not directly attached to a pressure vessel or cylinder.

For better understanding the context of a sealing system applied with such valves, a brief review of the known valves is incorporated herein as follows:

### Valves Using Shuttle Pistons

With reference to FIGS. 1 and 2, a prior art flow control system is shown such as that described in Applicants' co-owned US patent application US 2005/0103382. As shown in FIG. 1, the prior art systems comprise a fluid valve body 10 which itself is installed in a structure such as the neck 5 of a high pressure cylinder 6. The valve body 10 comprises a first opening or inlet 11, a first inlet filter 12, a shuttle valve 13, and a second withdrawal filter 14 at a second opening or cylinder outlet 15. In the context of an in-cylinder valve, the inlet 11 alternates between acting as a fluid inlet from a first pressure area P1, such as a higher pressure source, during filling of a lower pressure second pressure area P2 or cylinder, and acting as a fluid outlet during emptying of the cylinder in the case that the second pressure area of the cylinder is the higher of the two pressures. A bi-directional main flow passage 16 extends between the inlet 11, through the inlet filter 12, to the shuttle valve 13, and through the withdrawal filter 14 to the outlet 15 and into the cylinder 6. The shuttle valve 13 is positioned in the main flow passage 16 intermediate the inlet 11 and the outlet 15. The shuttle valve 13 is operative for opening and closing the main flow passage 16. The shuttle valve 13 comprises a double acting shuttle piston 30 movable in a shuttle bore 31. The shuttle piston 30 has a first shuttle face 32 and a backpressure face 33 and the piston 30 is movable under differential pressure thereacross. The first shuttle face 32 has a seal face 34 formed thereon for alternately sealing a flow port 35 along the main flow passage 16. The shuttle bore 33 intersects, and is in fluid communication with, main flow passage 16 so that the first shuttle face 32 is in communication with the main flow passage 16 between the seal face 34 and the second area P2. The shuttle piston 30 is biased at 36 for closing the main flow passage 16. Pilot operation is provided using a bypass or backpressure passage 17 about the shuttle valve 13. A second valve such as a direct-acting, high pressure solenoid valve 20, controls communication of flow between the main flow passage 16 and the backpressure passage 17. The backpressure passage 17 is in fluid communication with the shuttle piston's backpressure face 33. The solenoid valve 20 alternately blocks and opens communication between main flow passage 16 at a point between the inlet 11 and the backpressure passage 17.

In one mode of operation such as for filling the cylinder 6 with gas, when the backpressure passage 17 is closed and in cases where a high supply pressure at the inlet 11,P1 is greater than a low storage pressure in the cylinder 6,P2, the shuttle valve 13 is opened by the differential pressure across the shuttle valve 13 and fluid can reach the cylinder 6,P2. When the backpressure passage 17 is opened to the main flow passage 16, differential pressure across the shuttle valve 13 equalizes and the shuttle valve 13 is biased closed. Without equalization of pressure acting against the backpressure face 33, the differential pressure across the shuttle valve 13 would not be actuable. Equalization occurs because fluid is metered into or out of the backpressure face 33. Fluid is metered from the backpressure face 33 though a bleed orifice 37 formed through the valve body or through the piston itself. As shown, the prior art shuttle piston 20 uses an O-ring seal 39 and the valve 13 uses a plug 38 incorporating the bleed orifice 37. The piston bore 31 intersects the main flow passage 16 at the flow port 35 so that the first shuttle face 32 are subject to the pressurized gas of the second pressure area P2 or cylinder 6. Differential pressure across the O-ring seal 39 causes differential force across the piston 30, urging the piston to open. In the absence of a differential pressure, or at very low differential pressures, a biasing such as a spring 36 urges the piston 30 to the closed position. The fluid at a backpressure side 17 of the piston 30 is controlled to enable formation of a differential pressure thereacross. The bleed orifice 37 enables fluid communication, albeit measured, between backpressure face 17 and the second pressure area P2. The pressure at the backpressure face 17 can be different than either the pressure at the first pressure area P1 or that at the first shuttle face 32.

The prior art O-ring sealing system has disadvantages including a not-insignificant friction in the piston bore 31 and wear. Further, the prior art use of a metal shuttle piston can creates particles and scratches the bore 31 and use of a nitrile based O-ring 39 can wear out after only about 40,000 cycles, limiting the cycle life of the valve. Wear material from the O-ring 39 and the piston 30 can damage other valve components; and the use of a metal ball to seal on a plastic seat requires additional force to prevent leaking. Therefore, a significant spring-biasing force is required to ensure there is no leaking of the system at low cylinder pressures. Further, for equalization; there is a requirement to machine a bleed orifice (−Φ0.16 mm) either through the shuttle piston 30 or the valve 10, such as through the shuttle plug 38, to provide the differential pressure required to displace the shuttle piston 30. Such a strong spring force, combined with the fixed leak rate from the bleed orifice 37, limits the system opening at cylinder pressures lower than 15 bar (gauge) or 15 bar(g) and results in a higher number and cost of components and a need to do sub-assemblies. Some advantages of the current valves include proven operation over a mid-range number of cycles (about 30,000),the significant mass of the piston and a metal ball to flow port seal assembly, and significant spring force combine to reduce the severity of the oscillation of the shuttle system when the cylinder is being filled.

### Embodiments of the Present Invention

Generally, a sealing system 100 for a shuttle valve 110 is employed in high-pressure valves to allow a reduced amount of gas-flow by a shuttle piston 130 (leak-by) for adjusting differential pressure thereacross.

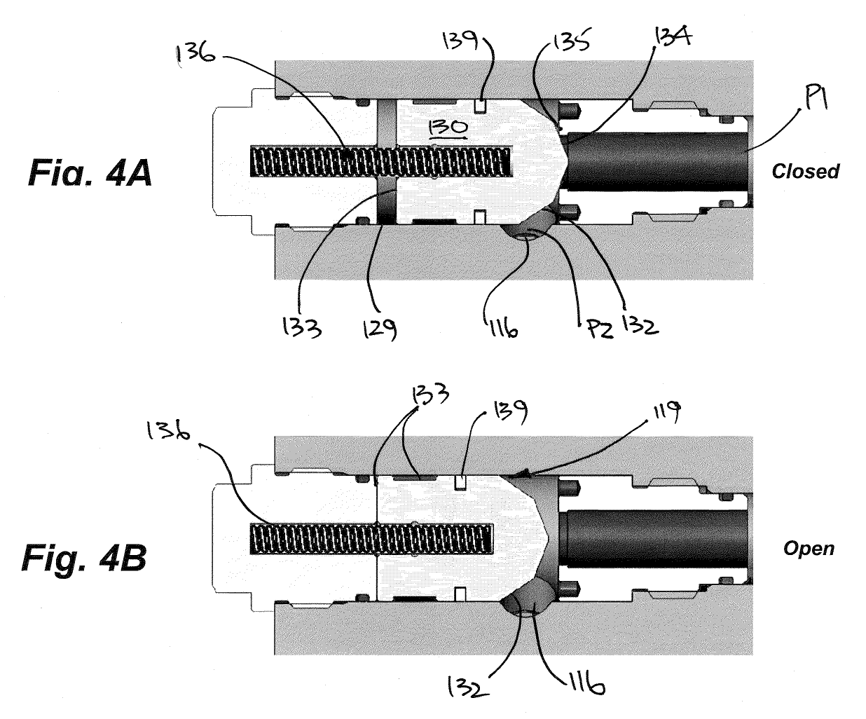

As shown in FIGS. 3 and 4, an embodiment of a sealing system 100 of the present invention comprises an annular seal ring 139 fit to a shuttle piston 130, enabling a leak-by flow. The present invention is suitable for application with a pilot-operated solenoid valve, such as that described in Applicants' co-owned U.S. Pat. No. 6,540,204 and Applicants' co-owned US patent application US 2005/0103382, the entireties of which are incorporated herein by reference.

As shown in FIG. 3 a pilot-operated valve 110 is fit with an embodiment of a sealing system 100, and with reference also to FIGS. 4A through 4D, comprising an on-off flow shuttle piston 130 and an annular sealing ring 139. The piston 130 is operable in a shuttle bore 131, forming an annular interface 119 therebetween. The piston 130 reciprocates between a closed position shown in FIG. 4A, seated against flow port 135, and an open position shown in FIGS. 4B,4D. The piston 130 has a first face 132 open to a main flow passage 116 and having a seal face 134 for sealing against the flow port 135 and a backpressure side 133 in a backpressure chamber 129 separated by the sealing ring 139 across which a pressure differential determines if the piston 130 shuttles to the closed or opened position. The shuttle piston 130 has a pressure equalization system thereacross. Rather than a prior art microscopic bleed port communicating with the backpressure chamber 129 at the backpressure side 133, pressure is equalized across the sealing ring 139. For example, for flowing gas along the main passage 116 from a high pressure at the second area P2 (such as from the cylinder) to a low pressure at P1, the backpressure face 133 is triggered by second valve 120 to be fluidly connected to the lower pressure first pressure area P1, reducing the pressure at the backpressure face 133 and permitting the high pressure in the main flow passage 16 at the shuttle's first face 132 to open the piston 130 under differential pressure. To close the valve 110, the backpressure face 133 is isolated from the first pressure area P1 and the higher pressure in the main flow passage 116 equilibrates across the seal ring 139 until the spring 136 bias-closes the valve 110. The greater the leak-by, the faster is the response to close the valve 110.

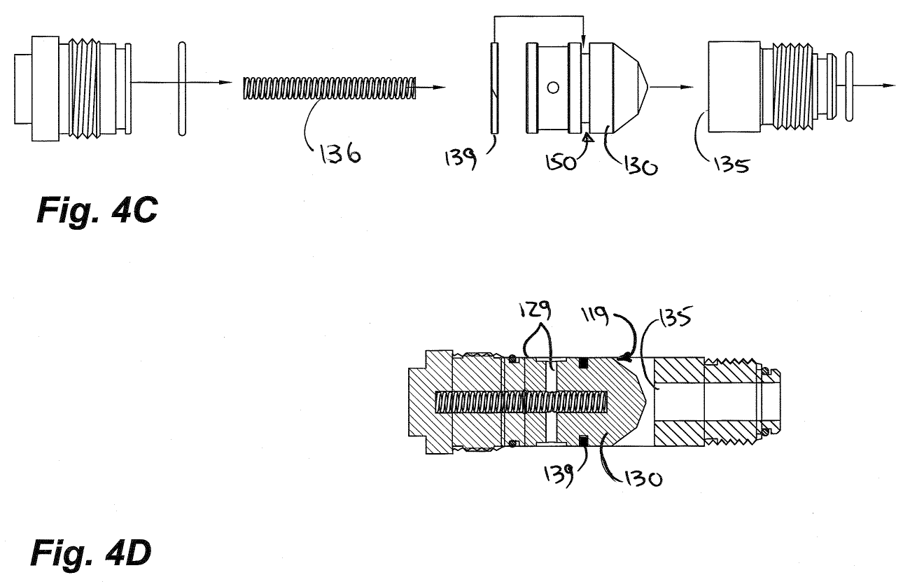

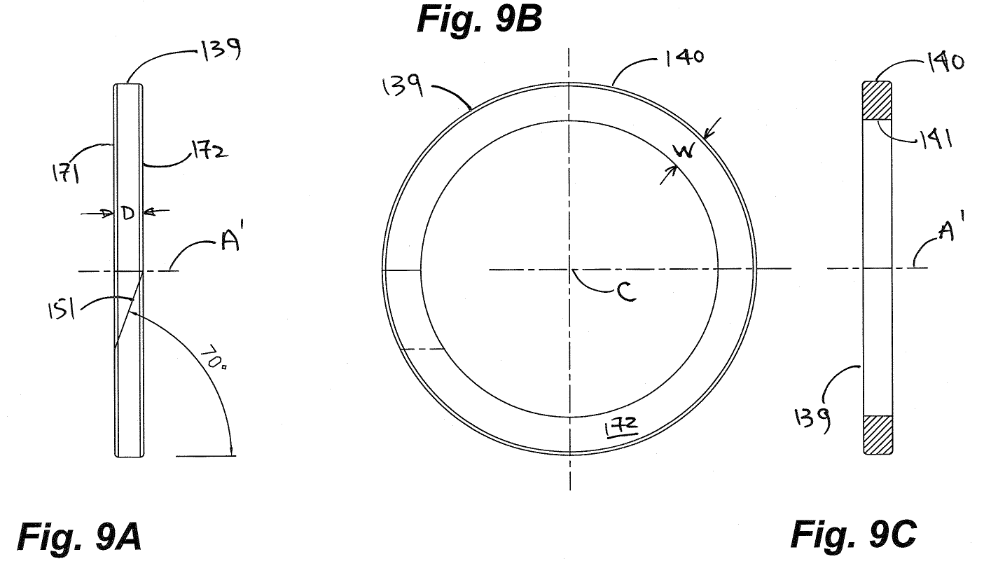

With reference to FIGS. 5 through 8, the integrity of the sealing ring's capability to seal to the piston bore 131 is deliberately and controllably compromised for metering a small, yet controlled, leak-by flow of fluid FL thereby. The sealing ring 139 is an annular ring having an outer cylindrical diameter forming an outer peripheral sealing face 140, an inner diameter forming an inner peripheral face 141, a width W between the outer and inner peripheral faces 140,141, and has an axial depth D. The inner peripheral face 141 can be substantially cylindrical.

The annular seal ring 139 is fit to a circumferentially-extending annular piston ring groove 150 formed in an outer periphery of the piston 130. The sealing ring 139 seals against the piston bore 131 and the piston ring groove 150. As shown in FIG. 5, the groove 150 has a bottom wall 160, has first and second seats or bounding side walls 161,162 for restraining the sealing ring 139 to the piston 130 during reciprocation, and is radially open to the piston bore 131. This description is set forth in the context of a bi-directional reciprocating piston which has no particular preferred orientation such up, down left or right. The piston 130 has an axis A, along which the piston 130 moves or shuttles.

Axial movement of the piston 130 is dictated by fluid dynamics and, in some operations, by biasing of the spring 136. Therefore axially-oriented components of the piston can be described with terms such as high pressure side and low pressure side may alternate as the pressure regime varies.

A leak-by fluid path L, flowing along the annular interface 119 between the piston 130 and the bore 121, is enabled by providing a split 151 through the sealing ring 139. As expected, fluid flows past the leak-by sealing ring 139 from the higher pressure area or upstream to the lower pressure downstream side.

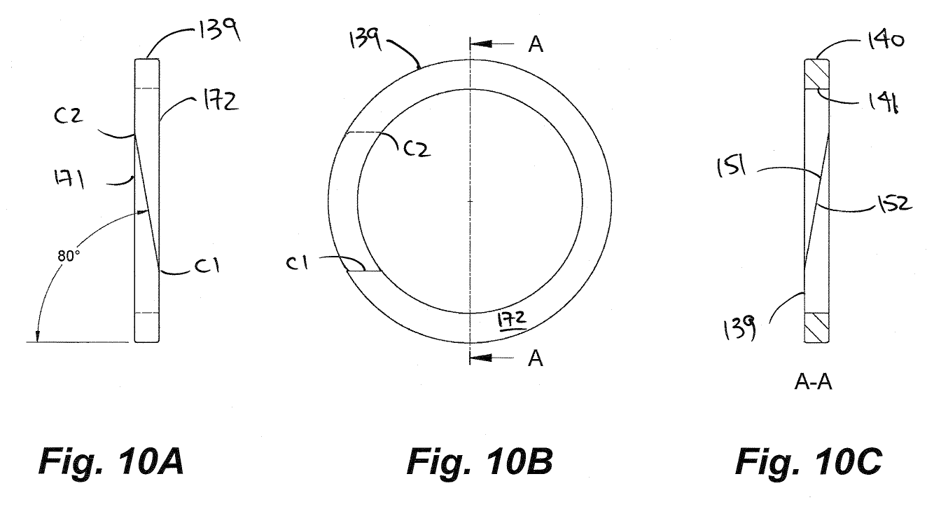

With reference to FIGS. 9A through 9C, the annular seal ring 139 has first and second side faces 171,172 which alternately engage the first and second bounding side walls 161,162 of the groove 150. The ring's side faces 171,172 cooperate with the piston ring groove's side walls 161,162 for substantially sealing the sealing ring 139 against a downstream bounding side wall 161 or 162 of the groove 150. As leak-by flow path L can be bidirectional along the annular interface 119 of the piston and bore, each of the side faces 171,172 can be alternately an upstream and a downstream face. The sealing ring 139 has a center C and an axis A′ which substantially coincides with the axis A of the piston 130 when installed thereto. The sealing ring 139 has an annular width W between the outer and inner peripheral faces 140,141.

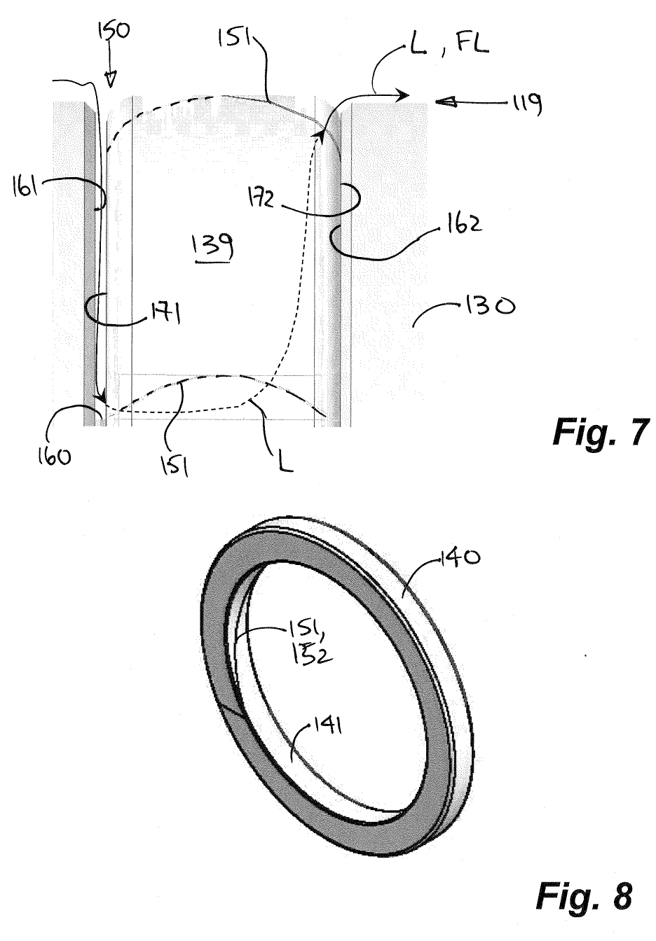

Returning to FIG. 5 and 7, the sealing ring 139 is compressible and has an uncompressed outside diameter at the sealing face 140 which is normally larger than the piston bore 131 and is elastically compressible thereto. The sealing ring 139 is discontinuous and can be temporarily expanded for installation over the piston 130 and into the piston ring groove 150. The groove 150 has a depth at least sufficient to receive the sealing ring 139 during installation of the piston 130 and sealing ring 139 to the piston bore 131. In one embodiment, the depth of the groove 150 between the piston's outer periphery to the groove's bottom 160 is about equal to or greater than the radial height or width W of the sealing ring 139 between the inner peripheral face 141 and the outer peripheral sealing face 140. The groove 150 has a groove extent between the bounding side walls 161,162 which is greater than the sealing ring's depth D between the first and second side faces 171,172.

As set forth above, during reciprocating motion, the sealing ring 139 seals against the piston bore 131 and is typically shifted under fluid pressure from an area of higher pressure to an area of lower pressure. The sealing ring 139 shifts downstream in the groove 150 wherein a downstream sealing side face 171 or 172 engages and seal against a downstream bounding side wall 161 or 162 of the piston groove 150. Without some other means for fluid transmission, fluid upstream of the seal ring is normally constrained from moving downstream past the outer peripheral face 140 by a seal formed at the piston bore 131, and fluid in the groove 150 is constrained from moving downstream further than the inner peripheral face 141 by a seal formed between the side face 171 or 172 of the sealing ring and the side wall 161 or 162 of the groove 150.

For enabling a controlled leak-by flow of fluid FL past the sealing ring 139, the sealing ring is split 151 entirely through its depth D along a cut surface 152 extending between a starting angular location C1 at one side face to a rotated angular location C2 on the other side face and entirely through its annular width W between the outer peripheral sealing face 140 and the inner peripheral face 141. Normally the sealing ring 139 is a unitary ring-shaped body, however the split 151 renders the ring discontinuous with overlapping beveled ends. While appearing generally helical, the cut surface 152 can be a straight cut which is on a plane perpendicular to a tangent, or a truly helical along a plane which rotates about the ring center C. The path of the cut surface 152 may be a two-dimensional plane, or a three-dimensional surface such a helical cut. Some types and methodologies of cutting rings is set forth in U.S. Pat. No. 5,087,057 to Kurkowski, the entirety of which is incorporated herein by reference. A consistent circumferential outer peripheral face 140 is maintained despite the split 151. Care is taken to minimize distortion of the outer peripheral face 140 and of the first and second side faces 171,172 which can occur during formation of the split 151.

With fluid seals formed between the outer peripheral face 140 and piston bore 131, and between the sealing ring's side faces 171 or 172 and groove bounding side walls 161 or 162, applicant believes that the leak-by fluid path L is forced to flow around the ring's annular width into the groove 150 to access the split at the inner peripheral face 141 of the sealing ring 139 before flowing radially outwards along the cut surface 152. As the sealing ring 139 is substantially sealed at the piston bore 131, the fluid flows along the cut surface towards a downstream angular location C1 or C2. Accordingly, the leak-by path L extends from the inner peripheral face 141 and generally radially outwards and axially downstream along the cut surface 152 to exit at the downstream seal face of the seal ring at the outer peripheral face 140 and the annular interface 119 of piston 130 and piston bore 131 Hydraulic forces on the upstream side face 171 or 172 of the sealing ring 139 can press the cut split together along the cut surface 152 as the downstream side face 172 or 171 bears against the downstream groove side wall 162 or 161 while the outer peripheral face 140 remains substantially unchanged and cylindrical.

One embodiment in which one would desire to deliberately establish a leak path is in metering seal system for metering fluid along the annular interface 119 into and out of a chamber 129 at one end of the piston 130 such as for adjusting a differential pressure between the first and second faces 132, 133. Where the piston 130 is driven in part due to differential pressure, and where the piston 130 has a chamber 129 at one end which may be closed for one reason or another, it is desirable to permit pressure, positive or negative (a vacuum) to equilibrate through an flow of fluid into or out of the chamber.

Returning to FIG. 3, the sealing system 100 of the present invention can replace the O-ring and bleed orifice of the pilot-operated valve disclosed in Applicant's co-owned US application 2005/0103382 A1. The valve 110 is provided for bi-directionally moving fluid between two areas and utilizes an improved shuttle valve seal system 100 implementing an embodiment of the leak-by seal ring. For example, the flow port 134 can control the flow of pressurized gas into or out of a storage cylinder (not shown).

The seal system 100 controls flow of fluid through the flow port 134 in the main flow passage 116 between the first area P1 normally at a first pressure and the second area P2 normally at a second pressure which is higher or lower than the first pressure. The cylindrical piston bore 131 is in fluid communication the flow passage 116, the piston 130 having a first piston face 132 in communication with the passage 116 and having a second backpressure face 133. The first face 132 having a seal face 134 adapted to seal to the flow port 135 and the piston being reciprocable in the bore 131 for alternately closing and opening the flow port 135 with the seal face 134. The leak-by sealing ring 139 is fit to the piston 130 and piston bore 131 for metering a leak-by flow fluid along the annular interface 119 to and away from the backpressure face 133 for adjusting a differential pressure between the first and second faces 132,133. The shuttle piston 130 valve is normally biased by spring 136 for closing the main flow passage 116, engaging the seal face 134 and the flow port 135. The backpressure passage 117 extends between the first area P1 and the backpressure face 133 and has a metering orifice 122 therealong. A bleed path extends between the second area P1 and the backpressure face 133, which is formed by the leak-by path L along the shuttle piston 130. A second valve, such as a high-pressure solenoid (HPS) valve 120, is operable for opening and closing the metering orifice 122 and affecting pressure at the backpressure face 133 for operating the piston 130 under active differential pressure or if the differential pressure is substantially zero, under biasing to close the flow port 135.

An example of operation, such as to withdraw a fluid from a cylinder, includes controlled flow of higher pressure fluid from the second area P2 to the first area P1. Higher pressure from the second area P2 is also initially present in the main flow passage 116, and also at the backpressure face 133 via metered leak-by through the sealing ring 139. Accordingly, there is initially no differential pressure across the piston 130 and the piston is biased closed to seal the seal face 134 against the flow port 135. The lower pressure of the first area P1 against the seal face 134 is insufficient to overcome the biasing. As described, the backpressure face of the shuttle piston 130 is also connected to the first area P1 via the backpressure passage 117 and controlled by the high pressure solenoid (HPS) 120. To commence fluid flow from the second area P2 to the first area P1, the HPS 120 is opened and the backpressure face 133 is placed in communication with the first lower pressure area P1. Any high pressure dissipates from the backpressure face 133, through the metering orifice 122, to the low pressure first area P1. At this point, the sealing ring 139 permits yet minimizes the gas flow or leak-by from the front face 132 of the shuttle piston 130 (at the high pressure of the main flow passage 116 and second area P2) towards the backpressure face 133 (now approaching the lower pressure of the first area P1), maintaining a differential pressure (HP>LP) that forces the piston 130 to displace to the open position.

When the HPS 120 is closed, leak-by across the sealing ring 139, from the higher pressure in the main passage 116 to the now isolated backpressure face 133 equalizes the pressure across the piston 130 (HP=HP), permitting the shuttle piston 130 to close under the force of biasing spring 136. One of skill in the art can see that similar examples can be seen to operate under reverse pressure conditions where the first area P1 is at a high pressure than the second area P2, such as during filling of a pressure cylinder.

For example, for flowing fluid from the first area P1 at high pressure to the second area P2 at a lower pressure, and initial condition can be with the HPS 120 open. High pressure along the backpressure passage 117 forms a high pressure at the backpressure face 133 and a pressure differential across the piston 130 to the lower pressure in the main passage 116 and at the at the piston face 132. The leak-by past the sealing ring 139 from the backpressure face 133 to the main passage 116 is insufficient to relieve the pressure differential (HP+biasing>LP). To commence flow the HPS 120 is closed. Leak-by across the sealing ring 139 dissipates pressure at the backpressure face 133 to the main flow passage 116, eventually equilibrating to the lower pressure of the second area P2. Any pressure differential across the piston 130 diminishes until the only forces on the piston are the biasing and the force generated by the higher pressure on the seal face 134 from the first area P1, resulting in a regulated flow past the seal face 134.

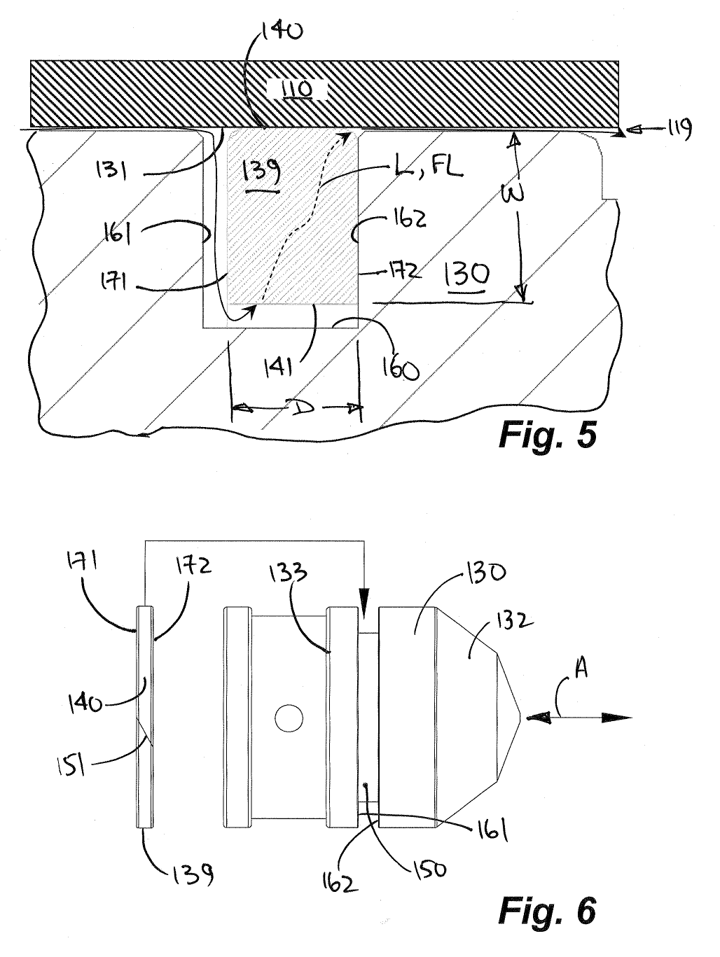

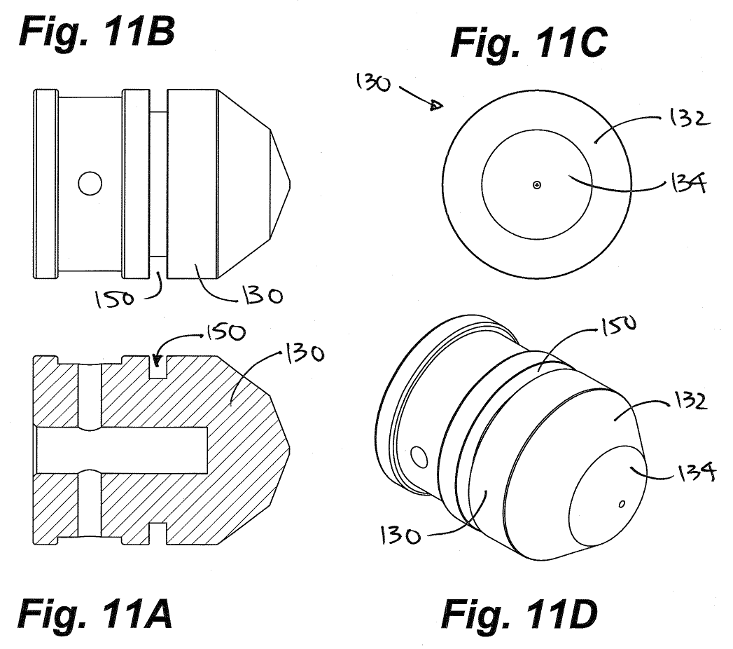

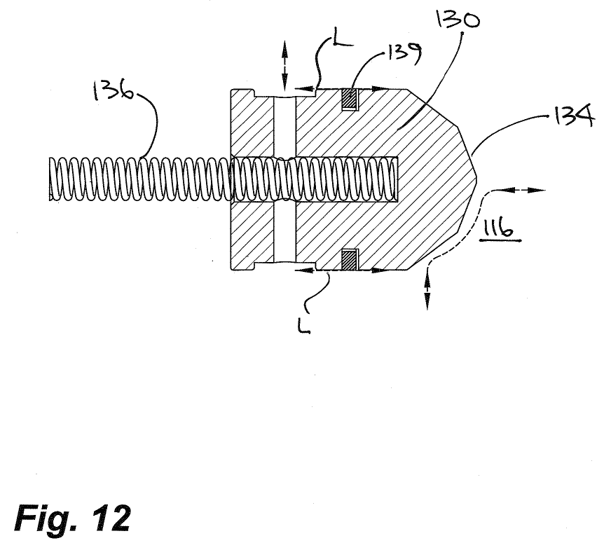

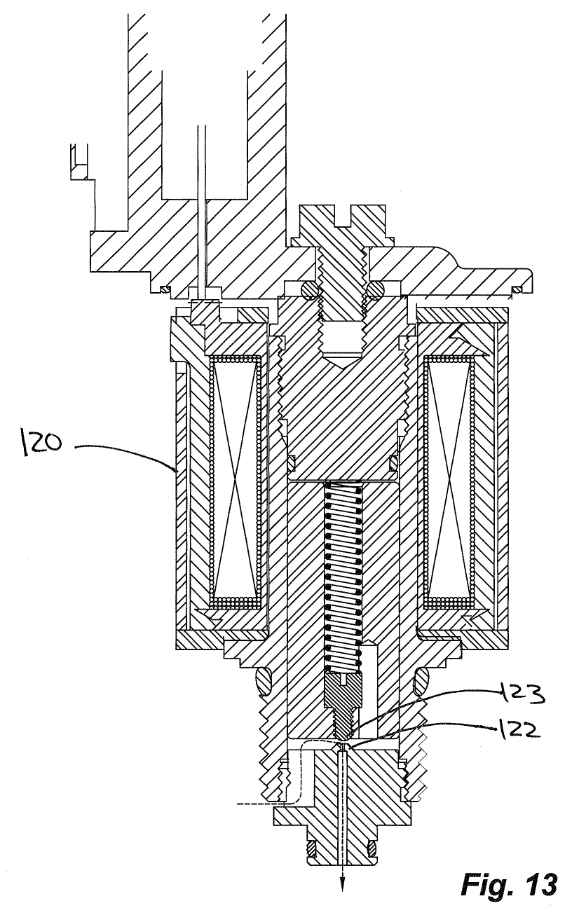

The sealing ring 139 can be made from a plastic with adequate mechanical, elastic, thermal and low wear properties, such as Acetal Copolymer (ACETRON™ GPTM, Quadrant EPP USA, Inc, of Reading, Pa.). As shown in FIGS. 6, 9A and 10A, the sealing ring 139 is split radially on a cut plane which is substantially parallel to the ring axis and angled off the ring's axis. For valves operating on automotive fuels, the angle can be about 60 to 85 degrees from the ring axis. The shuttle piston 130 itself can be made from a plastic with adequate mechanical, thermal and low wear properties, such as polyetheretherketone (PEEK) such as KETRON® PEEK 1000, Quadrant EPP USA, Inc ). The seat of the flow port 135 can be made from a bronze with adequate mechanical and abrasion resistance properties, such as UNS-C95400. In order to create an adequate sealing surface and prevent leaks at all pressures, the outlet bore on the seat of the flow port is smooth. In addition, a small radius in the intersection of the outlet bore and the sealing surface of the port seat is machined. The purpose of the radius is twofold: 1) to pilot or center the shuttle piston, and 2) to prevent formation of wisps.

In the embodiment of the sealing system 100, the flow rate of the migration or leak-by path L across the sealing ring 139 is at about ¼ of the flow rate of the flow through the metering orifice 122 of the HPS. The rate of the leak-by increases as cutting plane angle becomes steeper or greater from the side face the leak rate at 70° to 85° being very small and the leak rate at 45 degrees being quite a bit larger.

Controlled migration or leak-by rates are achieved by one or more of: controlling the surface finishes on the shuttle piston groove bounding side walls 161,162 and sealing ring side faces 171,172; designing the sealing ring 139 so that its nominal uncompressed diameter is slightly larger (by about 0.013 mm) than the piston bore diameter (on a nominal 13 mm diameter); and splitting the ring with a steep angle (between 70° and 85°). By means of these three steps, the leak-by path L on the sealing ring 139 is limited primarily to along the ring split, minimizing the flow along the intersection of the sealing ring outer peripheral face 140 and the bore 131. Using a steep angle on the ring, from the axis A′, aids in maintaining the integrity of the seal along most of the circumferential intersection between the outer peripheral face and the bore 131, as shown in FIGS. 5 and 7. The split ring further enables expansion and fitting of the sealing ring over a unitary piston and thereby avoids a multi-piece piston assembly.

The main advantages of the new sealing system include: simplified shuttle piston and shuttle seat design; operational between temperatures of −40 C through 85 C, all moving parts of the shuttle system can be plastic, therefore minimizing possibility of damage/contamination of other valve components; the ring and piston have a low coefficient of thermal expansion; minimal wear of the moving pistons and absent wear/scratches in the bore where the piston operates; the system performs well independently of the number of cycles and makes possible 100,000 or more cycles of the solenoid valve; optimized geometry and materials allows the system to seal with minimal additional force, therefore, a small spring force ensures there is no leaking of the system at low tank or cylinder pressures; no requirement to machine bleed holes (−Φ0.16 mm) on the shuttle piston or shuttle plug; the reduced spring force, combined with the low leak rate from the sealing ring, allows the system to open at very low cylinder pressures, as low as 0.5 barg; and lower cost of components with reduced need for sub-assemblies. The lower mass of the plastic shuttle piston 130 combined with the smaller spring force can make the shuttle prone to oscillation in occasional circumstances such as when the fluid fuel system is substantially static at low differential pressures (this oscillation is limited to very low pressures [<20 barg], and when the cylinder pressure (second area P2) approaches the pressure of the fill source (first area P1). The tendency to oscillate can be minimized by selecting an adequate combination of preload and spring rate.

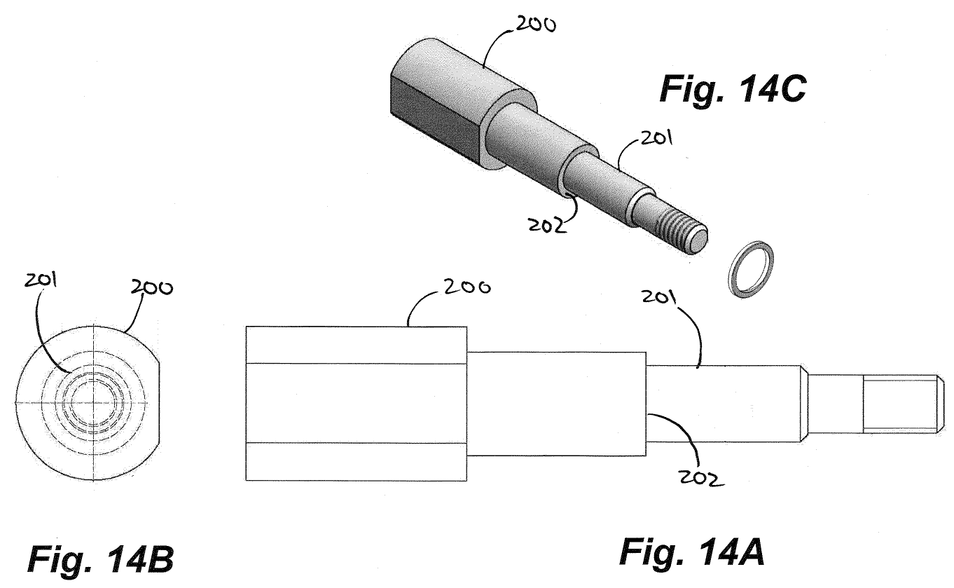

With reference to FIG. 13, in another embodiment of the invention, the high pressure solenoid 120 and control orifice 122 are improved over the prior systems. The sealing face 123 of the solenoid 120, for opening and closing the control orifice 122 is more easily calibrated and adjusted axially by threaded insert. The assembly method also allows for easier servicing of the shuttle.

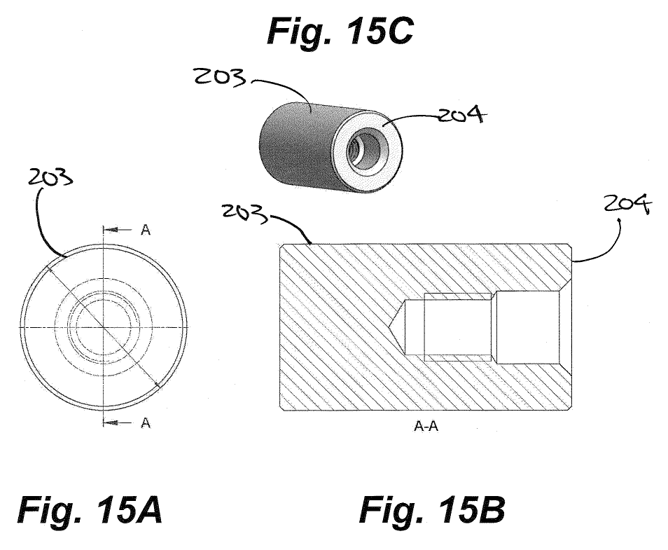

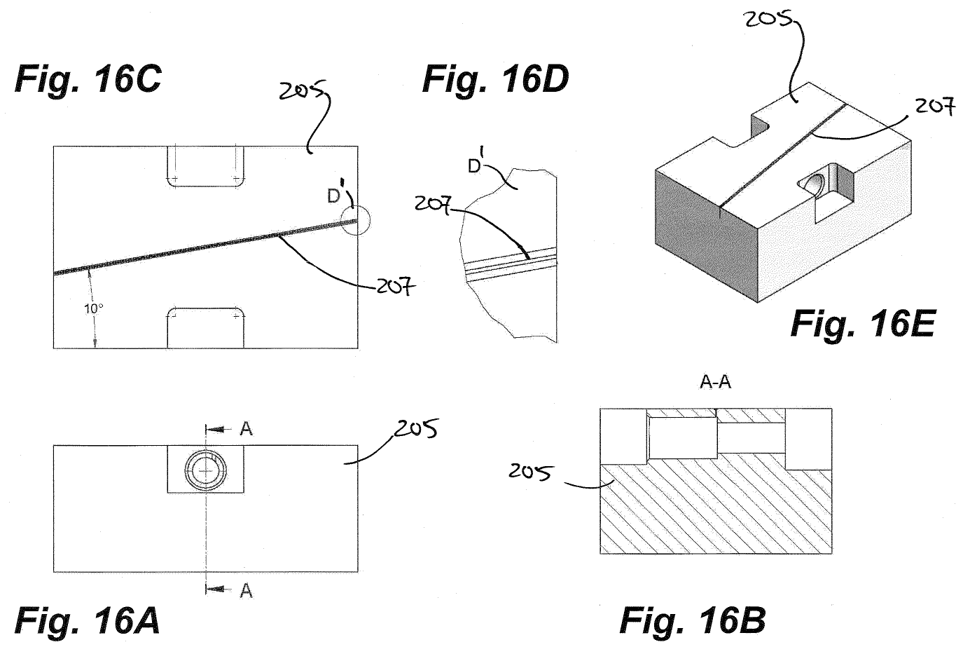

With reference to FIGS. 14A-17, a methodology and apparatus suitable for forming the split 151 in the sealing rings 139. As shown in FIG. 14C a sealing ring 139 is fit to a mandrel 200. The mandrel 200 can formed of acetal copolymer such as ACETRON™ GP from Quadrant and, as shown in FIGS. 14A and 14B, is a multi-stepped cylinder forming a cylindrical support 201 for the inner peripheral face 141 and a first shoulder 202 for a side face 171. In FIGS. 15A to 15C, a retainer nut 203 is threadably fit to the mandrel 200 for sandwiching the sealing ring 139 between the mandrel's first shoulder 202 and a second shoulder 204 formed by the retainer nut 203. With reference to FIGS. 16A through 16E, a jig or cut block 205 is prepared for the desired angle of the split 151. The cut block 205 comprises a receiving bore 206 adapted for receiving the mandrel 200, and an angled cutting guide 207 extending through the cut block 200 for intersecting the mandrel 200 at the sealing ring 139. As shown in FIG. 16C, the cutting guide is from the mandrel, in this instance at 10°, corresponding with an 80° split. As shown in detail at D″, the cutting guide 207 is chamfered.

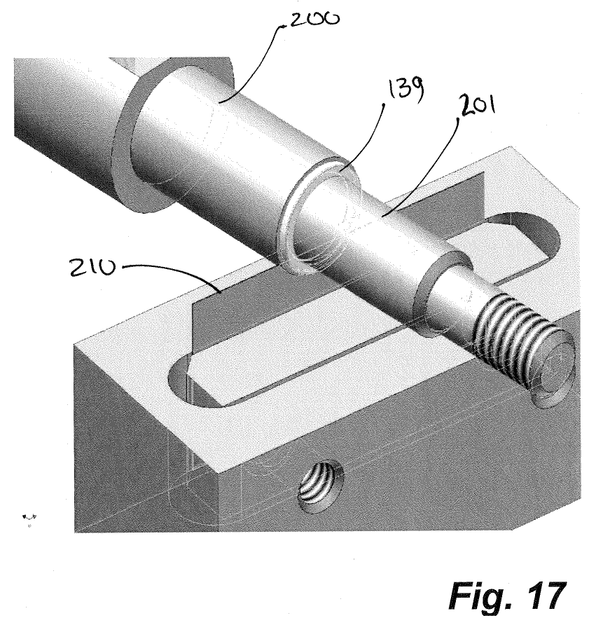

With reference to FIG. 17, the mandrel 200 with sealing ring 139 are fit to the cut block (cut block and retainer nut omitted for clarity) and a razor blade 210 is forced radially inward to cut the ring from the outer peripheral face 140 towards the ring center. The razor blade 210 mounted on a blade block 211 to cut the rings 139, maximizing the quality of the cut, and ensure that the cut is done at the precise angle required. As a typical razor blade 210 has a straight edge, the cylindrical support 201 of the mandrel 200 is fit with a slot (not detailed) radially beneath the ring to permit the blade to cut through the ring 139 and extend partially into the shaft without damage to the blade 210. Alternatively, a first cut through a ring 139 can include cutting into the cylindrical support 201 to form the slot or relief. The slot can be cleaned of burrs and the like before subsequent rings are cut.

The embodiments of the invention for which an excllusive property or privilege is claimed are defined as follows:

1. A seal system for metering fluid under differential pressure comprising:
a piston reciprocable in a cylindrical piston bore, the piston bore having a backpressure chamber at a backpressure face of the piston and an annular seal groove being open to the piston bore and having first and second bounding side walls; and
a unitary yet discontinuous annular sealing ring fit to the groove, the sealing ring having a center and an axial axis, a substantially cylindrical outer peripheral sealing face which is elastically compressible for sealingly engaging the piston bore at an annular interface, a first side face, a second side face, an axial depth between the first and second sides faces, an inner peripheral face and an annular width between outer peripheral sealing face and the inner peripheral face, the sealing ring further having an angled split entirely through its axial depth along a cut surface extending between a starting angular location at the first side face to a rotated angular location at the second side face and entirely through its annular width between the outer peripheral sealing face and the inner peripheral face,
wherein a leak-by of fluid along the split of the sealing ring and along the annular interface for equalizing the differential pressure across the piston.

2. The seal system of claim 1 wherein the cut surface is a substantially straight cut.

3. The seal system of claim 1 wherein the cut surface is a substantially helical cut.

4. The seal system of claim 1 wherein the angled split is at about 45 to 85 degrees from the axial axis.

5. The seal system of claim 4 wherein the angled split is at about 80 degrees from the axial axis.

6. The seal system of claim 1 wherein the annular sealing ring has a substantially rectangular cross-section.

7. The seal system of claim 6 wherein the first and second side faces are radially extending.

8. The seal system of claim 1 wherein the piston and sealing ring are formed of plastic.

9. The seal system of claim 1 wherein the piston is formed of polyetheretherketone.

10. The seal system of claim 1 wherein the sealing ring is formed of acetyl copolymer.

11. The seal system of claim 1 wherein the first and second side faces alternately seal against first and second bounding side walls.

12. A shuttle valve for a controlling flow of fluid through a flow port in a main flow passage utilizing the seal system of claim 1 wherein:
the piston bore is in fluid communication at a first end with the main flow passage and the piston bore forms the backpressure chamber at a second end;
the piston having a first face exposed to the main flow passage and the backpressure face at a second face, the first face having a seal face adapted to seal to the flow port, the piston being reciprocable in the piston bore for alternately closing and opening the flow port with the seal face,
wherein the seal system meters fluid along the annular interface into and out of the backpressure chamber for adjusting a differential pressure between the first and second faces.

13. The shuttle valve of claim 12 wherein the main flow passage fluidly connects a first area at a first pressure to a second area at a second pressure.

14. The shuttle valve of claim 13 further comprising a backpressure passage between the backpressure chamber and the first area.

15. The shuttle valve of claim 14 further comprising a second valve along the backpressure passage between the backpressure chamber and the first area wherein
when the second valve is open, a differential pressure can be formed between the backpressure face and the first face in spite of the leak-by along the split of the sealing ring, and
when the second valve is closed, the leak-by of fluid equilibrates the pressure between the backpressure face and the first face.

16. The shuttle valve of claim 15 further comprising a spring for biasing the piston to close the flow port wherein, when the second valve is closed, the leak-by of fluid equilibrates the pressure between the backpressure face and the first face and the spring biased to close the flow port.

17. The shuttle valve of claim 16 wherein the first pressure is a higher pressure and the second pressure is a lower pressure, and wherein
when the second valve is open, a differential pressure is formed between the higher pressure at the backpressure face and the lower pressure at the first face in spite of the leak-by along the split of the sealing ring, forcing the piston to close the flow port, and
when the second valve is closed, the leak-by of fluid equilibrates the lower pressure between the backpressure face and the first face and the spring biases the piston to close the port and the higher pressure at the seal face urges the piston to open the flow port, regulating fluid flow through the flow port.

18. The shuttle valve of claim 16 wherein the first pressure is a lower pressure and the second pressure is a higher pressure, and wherein
when the second valve is open, a differential pressure is formed between the lower pressure at the backpressure face and the higher pressure at the first face in spite of the leak-by along the split of the sealing ring, forcing the piston to open the flow port, and
when the second valve is closed, the leak-by of fluid equilibrates the higher pressure at the backpressure face and at the first face and the spring biases the piston to close the flow port and the lower pressure at the seal face urges the piston to open the flow port, regulating fluid flow through the flow port.

19. The shuttle valve of claim 18 wherein when the second valve is closed, the spring biases the piston to close the flow port despite the lower pressure at the seal face.
